(19) United States
(12) Patent Application Publication
(10) Pub. No.: US 2009/0059133 A1
(43) Pub. Date: Mar. 5, 2009

(54) LIQUID CRYSTAL DISPLAY DEVICE

(75) Inventor: WEI-KUO SHIH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/964,813

(22) Filed: Dec. 27, 2007

(30) Foreign Application Priority Data
Aug. 31, 2007 (CN) 200710201570.7

(51) Int. Cl. G02F 1/1335

(52) U.S. Cl. 349/95

(57) ABSTRACT

A liquid crystal display device (20) includes a backlight module (22), a liquid crystal module (24) and a lens module (25). The backlight module is used to emit light. The liquid crystal module is mounted on the backlight module. The lens module is set in front of the liquid crystal module. The light emitted from the backlight module passes the liquid crystal module and is focused by the lens module, thus the light being color mixed before reaching viewer's eyes.

### BACKGROUND OF THE INVENTION

1. Field of the Invention

The present invention relates to liquid crystal display devices, particularly to a liquid crystal display device with color mixing function.

2. Description of Related Art

In recent years, liquid crystal display devices are widely used in electronic devices, such as televisions, computers, mobile phones and PDAs. A typical liquid crystal display device 10 includes a backlight module 12, and a liquid crystal module 14. The liquid crystal module 14 has a first glass plate 142, a liquid crystal layer 144, an optical filter 146 and a second glass plate 148, which are arrayed in the order written. An alterable voltage controlled by an adjusting button on the outside of the liquid crystal display devices is applied between the first glass plate 142 and the second glass plate 148. The arrayed direction of the liquid crystal molecules in the liquid crystal layer 144 is changed according to different voltage. Thus, the brightness of the liquid crystal display devices can be adjusted by changing the voltage between the first glass plate 142 and the second glass plate 148.

The backlight module 12 is used to emit light. The light from the backlight module 12 pass the first glass plate 142 and reach the liquid crystal layer 144. The optical axis direction of the light is changed by the liquid crystal molecules in the liquid crystal layer 144. The optical filter 146 filtrates the light into red (R), green (G) and blue (B) rays. The red, green and blue rays pass the second glass plate 148. The red, green and blue rays become mixed and appear as a mixed color (e.g. white light) to the viewer.

However, some people are more sensitive to certain colors than other people, thus the liquid crystal display device 10 will be perceived to have different color display properties according to the color sensitivity of the viewer. In addition, the red, green, blue rays are separately emitted from the liquid crystal display device 10. This may affect the brightness of the liquid crystal display device 10.

Therefore, a new liquid crystal display device is desired in order to overcome the above-described problems.

### SUMMARY OF THE INVENTION

In one embodiment thereof, a liquid crystal display device includes a backlight module, a liquid crystal module and a lens module. The backlight module is used to emit light. The liquid crystal module is mounted on the backlight module. The lens module is positioned in front of the liquid crystal module. The light emitted from the backlight module passes the liquid crystal module and is focused by the lens module, thus the color of the light is mixed before reaching the viewer.

Other advantages and novel features will become more apparent from the following detailed description when taken in conjunction with the accompanying drawings.

### BRIEF DESCRIPTION OF THE DRAWINGS

Many aspects of the liquid crystal display device can be better understood with reference to the following drawings. The components in the drawings are not necessarily drawn to scale, the emphasis instead being placed upon clearly illustrating the principles of the present liquid crystal display device. Moreover, in the drawings, like reference numerals designate corresponding parts throughout the several views.

FIG. 1 is an exploded, schematic view of a liquid crystal display device, in accordance with an embodiment of the present invention.

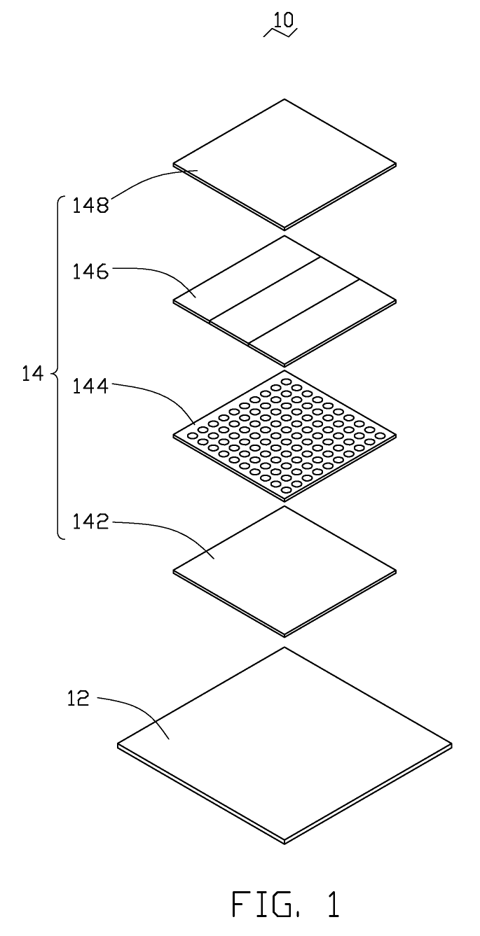

FIG. 2 is an assembled and sectional view of the liquid crystal display device shown in FIG. 1.

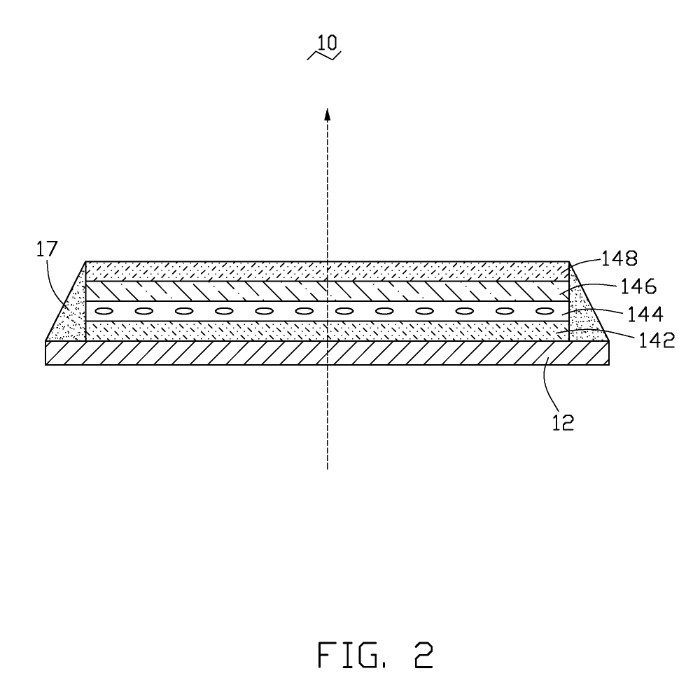

FIG. 3 is an exploded, schematic view of conventional liquid crystal display device.

FIG. 4 is an assembled and sectional view of the liquid crystal display device shown in FIG. 3.

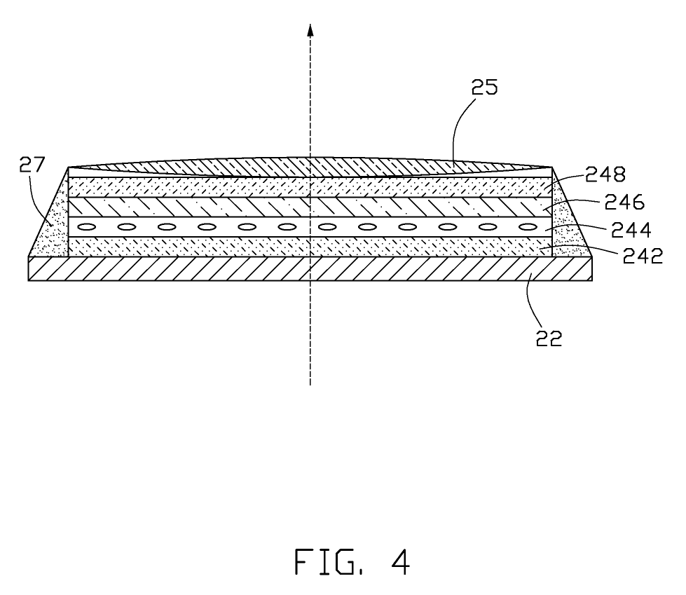

### DETAILED DESCRIPTION OF THE INVENTION

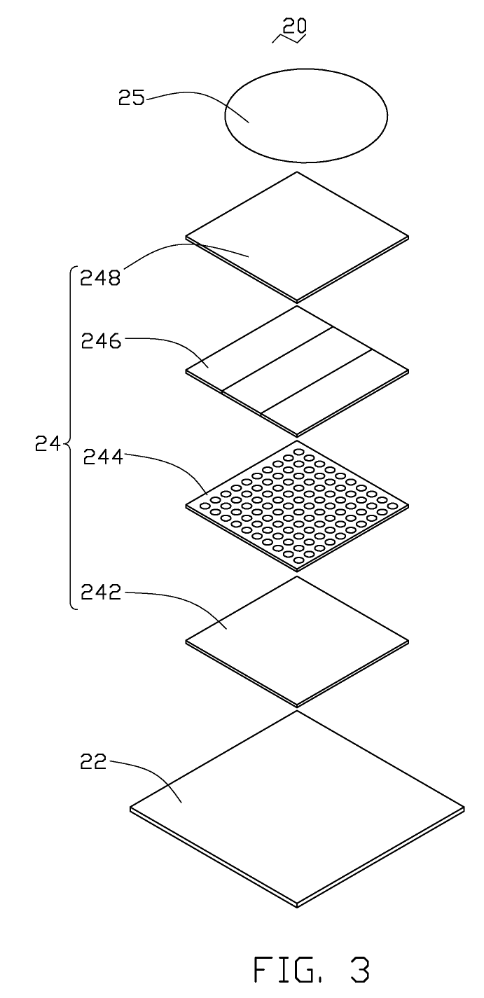

Referring now to FIG. 3, a liquid crystal display device 20 includes a backlight module 22, a liquid crystal module 24 and a lens module 25, in accordance with an embodiment of the present invention. The backlight module 22, the liquid crystal module 24 and the lens module 25 are arrayed in the order written and are jointed together by packaging material, such as adhesive. The backlight module 22 has light emitting diodes or cold cathode fluorescent lamps for emitting light therefrom.

The liquid crystal module 24 includes a first glass plate 242, a liquid crystal layer 244, an optical filter 246 and a second glass plate 248, which are arrayed in the order written. The first glass plate 242 and the second glass plate 248 are transparent. A circuit loop (not shown) having a battery is configured for connecting the first glass plate 242 with the second glass plate 248 so as to form voltage between the first glass plate 242 and the second glass plate 248. The first glass plate 242 is positioned between the backlight module 22 and the liquid crystal layer 244. The first glass plate 242 and the second glass plate 248 each respectively have a transparent electroplated layer formed on a surface thereof. Thus, the first glass plate 242 and the second glass plate 248 can function as two electrode plates. The electroplated layers can be made of an oxide of indium and tin, which is called ITO film.

The liquid crystal layer 244 is positioned between the first glass plate 242 and the second glass plate 248. The liquid crystal of the liquid crystal layer 244 is in a mesomorphic state. The direction of the liquid crystal molecule is controlled by the electric field formed between the first glass plate 242 and the second glass plate 248. The liquid crystal layer 244 composed of a substance such as, for example, lithium niobate (LiNbO3), lithium molybdate (Li2MoO4) and potassium dihydrogen phosphate (KH2PO4), is nematic phase.

The optical filter 246 is positioned between the liquid crystal layer 244 and the second glass plate 248. The light emitted from the backlight module 22 is separated to red (R), green (G) and blue (B) rays after passing through the optical filter 246.

The lens module 25 is a convex lens, and is configured for focusing the red (R), green (G) and blue (B) rays. Thus, the red (R), green (G) and blue (B) rays is mixed together after passing through the lens module 25. Therefore, the mixed color generated from the lens module 25 allow viewers with poor color senses to also be able to see a living picture from the liquid crystal display device 20. Since the light from the backlight module 22 is focused by the lens module 25, the brightness of the display is increased. It should be understood that when the viewer's eyes are positioned at the focus of the convex lens, the red (R), green (G) and blue (B) rays are focused on a point, so that the color is fully mixed to generate a better picture.

It should be understood that the liquid crystal display device 20 may have millions of pixels and the number of the convex lens is changed accordingly. Each convex lens corresponds to one pixel and focuses the red (R), green (G) and blue (B) rays from the corresponding pixel. It should be understood that each convex lens can also correspond to several pixels, and the convex lens focuses the rays from the corresponding pixels. The light from the backlight module 22 are color mixed before reaching viewer's eyes, so as to improve the brightness and quantity of the liquid crystal display device 20.

It should be understood that the optical filter 246 can be changed to be other type, e.g., the optical filter 246 can separate the light emitted from the backlight module 22 into not only red (R), green (G) and blue (B) rays, but also into while (W) rays. The while (W) rays can increase the brightness of the liquid crystal display device 20 and improve the display effect of the liquid crystal display device 20.

It should be understood that the optical filter 246 can be directly formed on the surface of the second glass plate 248 as a film, and the transparent electroplated layer of the second glass plate 248 is formed on the optical filter 246. This can reduce the thickness of the liquid crystal display device 20. The optical filter 246 as a film can be preparative and is attached to the surface of the second glass plate 248. The optical filter 246 as a film can also be formed by coating optical filtering material on the surface of the second glass plate 248.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a backlight module for emitting light;
a liquid crystal module mounted on the backlight module; and
lens module placed in front of the liquid crystal module;
wherein, the light emitted from the backlight module passes the liquid crystal module and is focused by the lens module, thus the light is color mixed before reaching viewer's eyes.

2. The liquid crystal display device as claimed in claim 1, wherein the lens module is made of at least one convex lens.

3. The liquid crystal display device as claimed in claim 2, wherein the liquid crystal display device has a plurality of pixels, the number of the convex lens is plural, and each convex lens corresponds to at least one pixel.

4. The liquid crystal display device as claimed in claim 1, further comprises packaging material for fastening the backlight module, the liquid crystal module and lens module together.

5. The liquid crystal display device as claimed in claim 1, wherein the liquid crystal module comprises a first glass plate, a liquid crystal layer, an optical filter and a second glass plate arrayed in the order written.

6. The liquid crystal display device as claimed in claim 5, wherein the first glass plate and the second glass plate are transparent.

7. The liquid crystal display device as claimed in claim 6, wherein a circuit connects the first glass plate with the second glass plate, the first glass plate and the second glass plate each respectively have a transparent electroplated layer formed on a surface thereof.

8. The liquid crystal display device as claimed in claim 5, wherein the liquid crystal layer is constituted by one of lithium niobate, lithium molybdate and potassium dihydrogen phosphate.

9. The liquid crystal display device as claimed in claim 5, wherein the optical filter operates on the light from the backlight module into red, green and blue rays.

10. The liquid crystal display device as claimed in claim 5, wherein the optical filter operates on the light from the backlight module into red, green, blue and white rays.

11. The liquid crystal display device as claimed in claim 7, wherein the optical filter is directly formed on the surface of the second glass plate, and the electroplated layer of the second glass plate is formed on the optical filter.
